(19) United States
(12) Patent Application Publication
(10) Pub. No.: US 2003/0030704 A1
(43) Pub. Date: Feb. 13, 2003

(54) Bimorph type actuator, ink jet head using the same, and manufacturing method thereof

(75) Inventors: Yoshiaki Sakamoto, Kawasaki (JP); Shuji Koike, Setagaya (JP); Tomohisa Shingai, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: FUJITSU LIMITED, Kawasaki (JP)

(21) Appl. No.: 10/252,689

(22) Filed: Sep. 24, 2002

Related U.S. Application Data
(63) Continuation of application No. PCT/JP00/01881, filed on Mar. 27, 2000.

(51) Int. Cl. B41J 2/045

(52) U.S. Cl. 347/68

(57) ABSTRACT

A bimorph type actuator for which the piezoelectric constant can be maintained even with a thin piezo film, and an ink jet head using the actuator, are disclosed. The bimorph type actuator comprises a diaphragm (18) having a fixed periphery, and a piezo film (19) formed on the diaphragm (18), and the center of the piezo film (19) has a bent shape. Residual stress in the piezo film (19) is thus released, and hence a desired piezoelectric constant can be realized even with a thin piezo film, and thus low-voltage driving becomes possible.

### TECHNICAL FIELD

The present invention relates to a periphery-fixed bimorph type actuator using a thin film piezo, an ink jet head using the actuator, and a manufacturing method thereof, and in particular to a bimorph type actuator for enabling low-voltage driving, an ink jet head, and a manufacturing method thereof.

### BACKGROUND ART

FIG. 9 is a drawing of the constitution of a conventional piezoelectric type ink jet head. As shown in FIG. 9, the multi-nozzle head has a constitution in which, on a nozzle plate 105 having a large number of nozzles 106, is provided a pressure chamber wall plate 103 that forms pressure chambers 104, and further are provided driving elements. The driving elements use periphery-fixed bimorph type actuators, and comprise a diaphragm 102 that also acts as a common electrode, piezo layers 101, and individual electrodes 100.

Miniaturization of such actuators and integration of a plurality of elements is realized by making the fixed supports in bimorph parts narrow and by making the bimorph parts thin. This is also the case when a piezo is used as the driving source of the bimorph part, and hence it is desired to make the piezos 101 thin.

Regarding the operation of the actuator, a strain force due to the piezoelectric effects of the piezo 101 (in particular the transverse effect orthogonal to the electric field) acts as a bending moment at the bending section neutral axis due to differences in the sectional shape (inparticular the thickness) and the Young's modulus between the piezo 101 and the electrodes 100 and 102 provided on the two surfaces of the piezo, and hence the bimorph structure as a whole bends. Due to this bending, pressure is applied to the pressure chamber 104, and hence ink drops are ejected from the nozzle 106.

The strain due to this transverse piezoelectric effect is proportional to the electric field strength (the ratio V/tp of the applied voltage V to the piezo thickness tp), and hence, so long as the piezoelectric constant does not change, by making the piezo thinner the same strain can be obtained with a proportionally lower voltage. That is, the thinner the piezo film, the lower the voltage required for driving.

In this case, by making it possible to obtain the desired characteristics with a lower voltage, the electrical circuitry that generates the electrical signals can also be made smaller, and hence the apparatus using the actuator in question as a whole can be made smaller and lower in cost. Examples of known methods for producing such thin piezos include a sputtering method and a sol-gel method, and piezos of thickness 10 μm or less produced by such a method are referred to as thin-film piezos. By applying such a bimorph type actuator to an ink jet head, one can expect that it will be possible to make the head smaller and increase integration.

However, even though it is easy to produce the shape of such thin-film piezos, due to the thinness it is difficult to sufficiently form a crystal structure (perovskite structure) that exhibits piezoelectricity, and hence there is a problem that it is extremely difficult to maintain or raise the piezoelectric constant, which is important in terms of the driving characteristics.

In particular, a thin-film piezo is formed by growing a monocrystal on a crystalline substrate, and as a consequence there has been a problem that the piezoelectric constant drops and low-voltage driving becomes difficult.

### DISCLOSURE OF THE INVENTION

It is an object of the present invention to provide abimorph type actuator, an ink jet head, and a manufacturing method thereof, for making low-voltage driving easy even though a thin-film piezo is used.

It is another object of the present invention to provide a bimorph type actuator, an ink jet head, and a manufacturing method thereof, for eliminating strain from during piezo production and improving piezoelectric characteristics.

To attain these objects, one form of the bimorph type actuator of the present invention has a diaphragm having a fixed periphery, a piezo film formed on the diaphragm, and an electrode film provided on the piezo film, wherein the piezo film has a shape when not being driven such that the center of the piezo film is bent towards the side of the electrode film.

Moreover, one form of the ink jet head of the present invention has a pressure chamber, a nozzle communicating with the pressure chamber, and a driving element that applies pressure to the pressure chamber for ejecting ink drops from the nozzle, wherein the driving element has a diaphragm having a fixed periphery on a wall member constituting the pressure chamber, a piezo film formed on the diaphragm, and an electrode film provided on the piezo film, and wherein the piezo film has a shape when not being driven such that the center of the piezo film is bent towards the side of the electrode film.

Furthermore, a multi-nozzle ink jet head of the present invention has a substrate in which are formed a plurality of pressure chambers and a plurality of nozzles communicating with the pressure chambers, a diaphragm provided on the substrate, a plurality of piezo films formed on the diaphragm that correspond respectively to the pressure chambers, and a plurality of electrode films provided respectively on the piezo films, wherein each of the piezo films has a shape when not being driven such that the center of the piezo film is bent towards the side of the electrode film.

In the present invention, by making the shape of the piezo film after formation of the piezo film be such that the center is bent, residual stress that arose during the production of the piezo film is released. The amount of strain relative to the electric field applied thus increases, and hence low-voltage driving becomes possible even with a thin-film piezo.

In another form of the present invention, by making the relationship between the maximum amount of bend δs of the piezo film and the fixed minor axis width w of the diaphragm be in the range δs/w≧0.04, an amount of bend can be obtained such that the piezoelectric characteristics can be improved.

In another form of the present invention, the piezo film has a perovskite crystal structure grown on a substrate, and hence the strain accompanying the crystal growth can be eliminated through the shape.

Moreover, in another form of the present invention, the diaphragm is constituted such that the piezo film bends when the substrate is removed, and hence the bend can be formed easily through the constitution of the diaphragm. Furthermore, by forming the bend through the thickness of the diaphragm, the bend can be formed yet more easily.

A method of manufacturing the bimorph type actuator of the present invention has a step of forming an electrode film on a substrate, a step of forming a piezo film on the electrode film, a step of forming a diaphragm on the piezo film, and a step of removing the substrate, thus causing the center of the piezo film to bend.

A method of manufacturing the ink jet head of the present invention has a step of forming an electrode film on a substrate, a step of forming a piezo film on the electrode film, a step of forming a diaphragm on the piezo film, a step of forming, on the diaphragm, an ink-ejecting member in which have been formed a pressure chamber and a nozzle, and a step of removing the substrate, thus causing the center of the piezo film to bend.

A method of manufacturing the multi-nozzle ink jet head of the present invention has a step of forming a plurality of electrode films on a substrate, a step of forming a plurality of piezo films respectively on the electrode films, a step of forming a common diaphragm on the plurality of piezo films, a step of forming, on the diaphragm, an ink-ejecting member in which have been formed a plurality of pressure chambers and a plurality of nozzles, and a step of removing the substrate, thus causing the center of each of the piezo films to bend.

With this invention, by removing the substrate, each of the bimorph parts can be made to be in a bent state even when not being driven by utilizing the residual stress from during the thin-film piezo formation, and hence the piezoelectric performance can easily be raised.

Other objects and forms of the present invention will become apparent from the following drawings and embodiments.

### BRIEF DESCRIPTION OF THE DRAWINGS

FIG. 1 is a drawing of the constitution of an ink jet printer of an embodiment of the present invention.

FIG. 2 is a top view of the ink jet head of FIG. 1.

FIG. 3 is a sectional view of the ink jet head of FIG. 2 along B-B.

FIG. 4 is a sectional view of the ink jet head of FIG. 2 along A-A.

FIGS. 5(A), 5(B) and 5(C) consist of drawings explaining the piezo film of FIG. 4.

FIG. 6 is a manufacturing process diagram for the ink jet head of FIG. 4.

FIG. 7 is a table of characteristics for examples of the present invention.

FIG. 8 is a graph of the relationship between curvature and piezoelectric constant for the present invention.

FIG. 9 is a drawing explaining a conventional ink jet head.

### BEST MODE FOR CARRYING OUT THE INVENTION

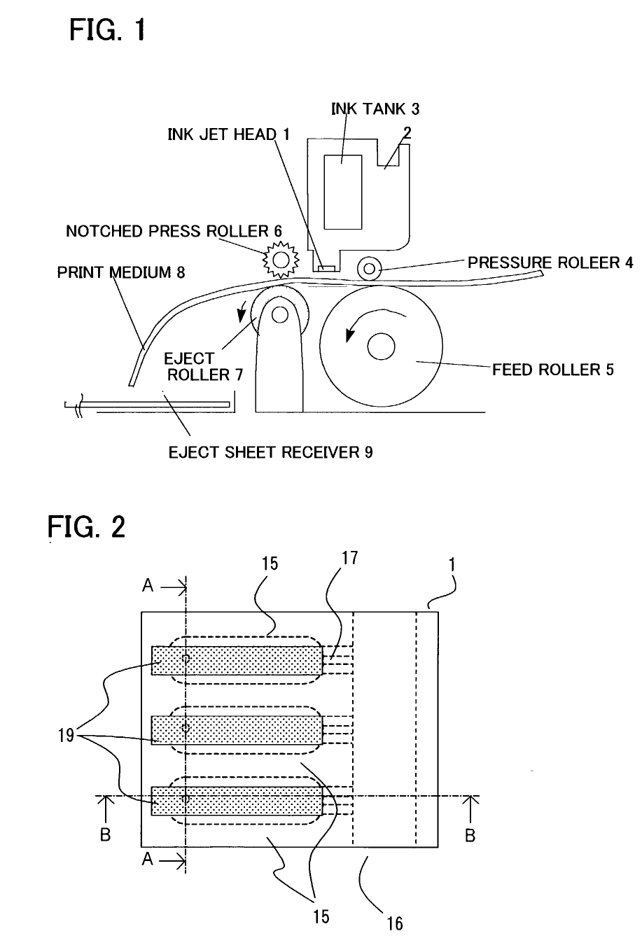

FIG. 1 is a drawing of the constitution of an ink jet printer of an embodiment of the present invention, and shows a serial printer. A printing medium 8 is conveyed in the direction of a discharged paper receiver 9 by a paper-feeding roller 5 and a pressing roller 4. A carriage 2 holds an ink tank 3 and an ink jet head 1, and moves in the principal scanning direction of the printing medium 8 (the direction into the page in the drawing). A paper-discharging roller 7, along with a notched pressing roller 6, conveys the printing medium 8 in the direction of the discharged paper receiver 9. The ink jet head 1 is thus moved in the principal scanning direction by the carriage 2 while the printing medium 8 is conveyed in the secondary scanning direction, and ink recording is carried out on the printing medium 8.

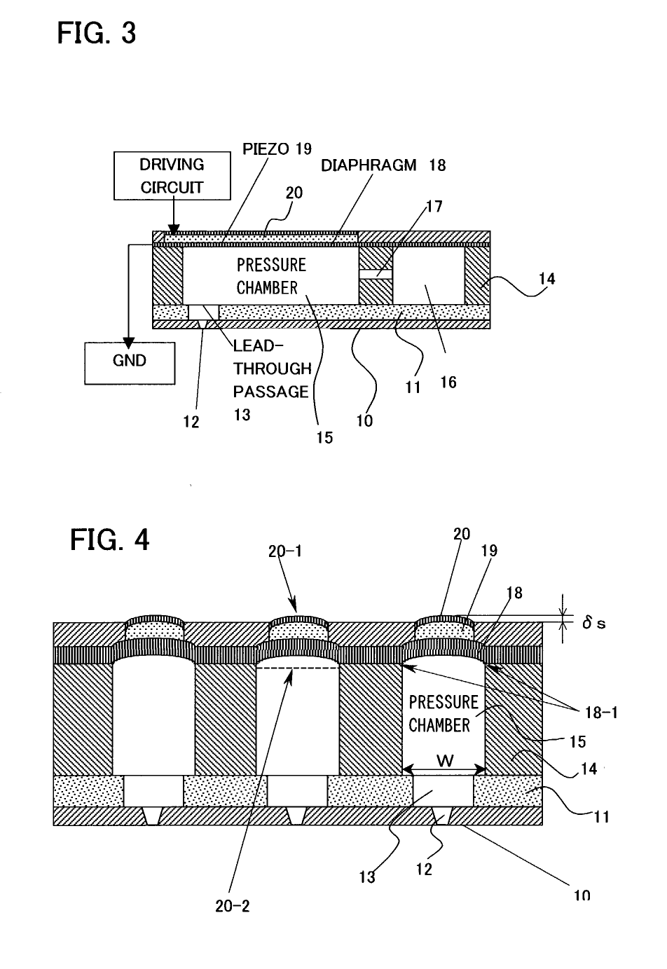

FIG. 2 is a top view of the ink jet head (hereinafter referred to as the ‘head’) 1, FIG. 3 is a sectional view of the head along B-B, and FIG. 4 is a sectional view of the head along A-A. The example of FIGS. 2 to 4 is a 3-nozzle multi-nozzle head. As shown in FIG. 2, three pressure chambers 15 are provided via ink supply channels 17 on a common ink chamber 16. A piezo film 19 is provided on each of the pressure chambers 15.

As shown in FIG. 3, the head 1 comprises a nozzle plate 10 in which nozzles 12 are provided, a lead-through channel plate 11 having lead-through channels 13, a plate 14 in which are formed the pressure chambers 15, the ink supply channels 17 and the common ink chamber 16, and bimorph type actuators. The bimorph type actuators comprise a diaphragm 18 that also acts as a common electrode, the piezo films 19, and individual electrodes 20.

The pressure chambers 15 communicate with the nozzles 12 via the lead-through channels 13. Ink is supplied into the pressure chambers 15 via the ink supply channels 17 from the common ink chamber 16, which communicates with the ink tank 3. The diaphragm 18 is electrically earthed, and by applying a driving voltage to an individual electrode 20 from a driving circuit, the bimorph driver bends, and pressure is applied to the pressure chamber 15. As a result, an ink drop is ejected from the nozzle 12.

Here, as shown in FIGS. 3 and 4, each bimorph driver is a periphery-fixed bimorph type actuator using a thin-film piezo 19. That is, the periphery of the diaphragm 18 is fixed to the plate 14. Moreover, as shown in FIG. 4, the planar accuracy (flatness) is made to be lower for the driving parts 20-1 than the periphery-fixing parts 18-1 of the bimorph drivers, with the bimorph parts having a bent shape even when not being driven. That is, the bimorph parts are bent from a flat shape 20-2 towards the side of the individual electrodes 20.

As will be described later, the bend in the bimorph parts when not being driven is formed by removing the substrate after the bimorph structure has been formed on the substrate, which is flat. Each of the periphery-fixed bimorph type actuators has a set of a piezo 19 and an electrode 20 positioned in a region inside from the periphery-fixing parts 18-1, and the constituent member 18 on the other piezo surface side has a shape broader than the piezo 19, with the periphery of the constituent member 18 being fixed.

Moreover, it is preferable for the bend in the bimorph parts when not being driven to satisfy the following relationship.

δs/w≧0.04 (δs: maximum amount of bend when not being driven, w: periphery-fixed minor axis width) Through this constitution, the piezoelectric performance of the thin-film piezo can be brought out amply, and desired driving characteristics can be realized with a low voltage. Moreover, because a thin-film piezo is used, it becomes easy to miniaturize the periphery-fixed bimorph type actuator, and to integrate a plurality of elements. Furthermore, through low-voltage driving, the electrical circuitry becomes simpler, which contributes to making the apparatus as a whole smaller and lower in cost. In particular, when the actuator is used as a driving source in an ink jet head, the effects are marked.

The characteristic features of the structure are as follows.

The actuator is a periphery-fixed bimorph type actuator using a thin-film piezo 19.

Periphery fixing is carried out at the diaphragm 18.

The diaphragm 18 is an electrically conductive material (Cr), and thus also acts as a common electrode for the plurality of actuators.

Each thin-film piezo 19 is formed in a region inside from the periphery-fixing parts of the diaphragm 18.

An individual electrode 20 is provided on the upper surface of each thin-film piezo (in a position sandwiching the piezo with the diaphragm).

When driving is not being carried out (when the actuator is stationary), the center 20-1 of each bimorph part is in a bent state such that the individual electrode surface 20 side is convex.

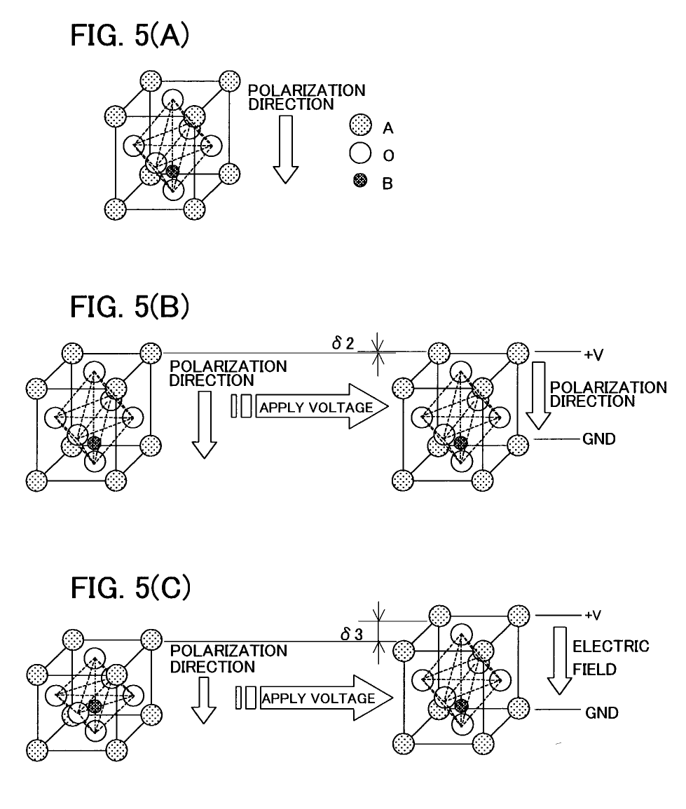

The effects of this bend will now be described using FIG. 5. As shown in FIG. 5(A), a thin-film piezo exhibiting a piezoelectric effect has a perovskite crystal structure. The general formula is ABO₃. The thin-film piezo is formed by crystal growth through sputtering or the like on a substrate. During production of the thin-film piezo, as shown in FIG. 5(A), a large amount of crystal strain arises due to differences in the lattice constant and the coefficient of thermal expansion between the substrate and the piezo, and hence ion B is greatly displaced downwards in the drawing. Here, because the rigidity of the substrate is high, this strain accumulates as residual stress in the laminate of the piezo film 19 and the substrate.

As shown in FIG. 5(B), in the case that no bend is formed as in a conventional bimorph driver, the residual stress of FIG. 5(A) is not released, and hence the crystal state is as in FIG. 5(A). From this state, even if an electric field is applied, the amount of movement of the ion B will be low, and hence 62 is almost zero. The piezoelectric constant d measured with this conventional shape is thus small.

However, as shown in FIG. 5(C), when a bend is formed in the bimorph driver as in the present invention, then the residual stress of FIG. 5(A) is released. The crystal strain is thus relaxed, and the ion B moves towards the center. So long as it is not above the Curie point or a coercive electric field, however, the polarization remains (the ion B remains in a state away from the center). In this state, when an electric field is applied, then the amount of movement of the ion B can be made large, and strain is generated. That is, δ3>δ2. By forming the bend, the measured piezoelectric constant d thus becomes larger than conventionally.

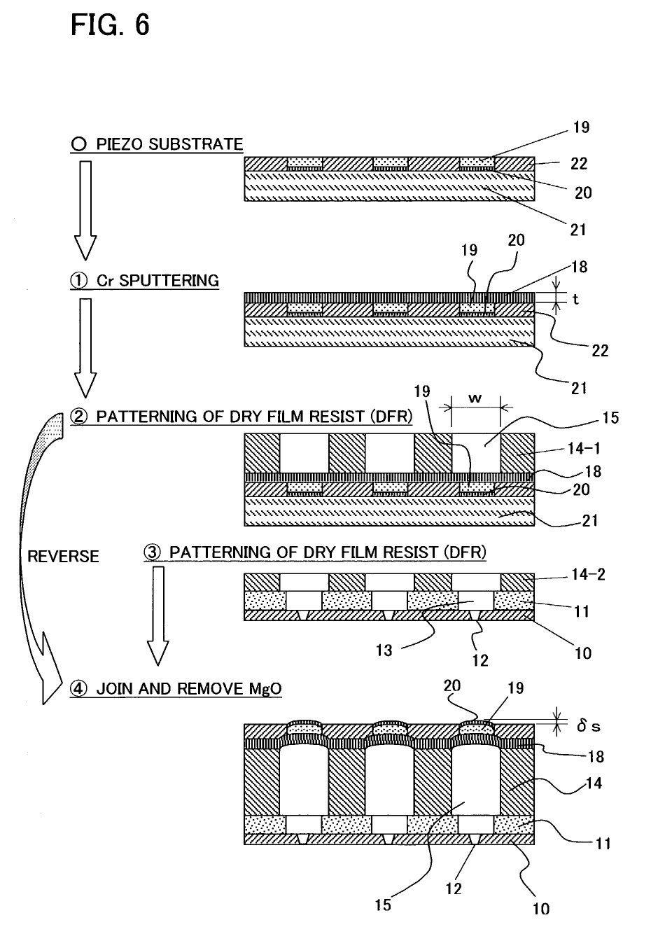

Next, a description will be given of a manufacturing process of an ink jet head using this bimorph type actuator, using FIG. 6. Firstly, individual electrodes 20 are formed from Pt or the like on an MgO substrate 21. Next, piezo films 19 are formed by sputtering via a mask 22 such as a photoresist. The resulting structure is referred to as the ‘piezo substrate’.

After forming the divided piezos, a common electrode cum diaphragm 18 is formed to a thickness t by Cr sputtering over the whole of the piezo substrate. In this example, the bend is formed through the thickness t, and the amount of bend depends on the thickness t.

Next, pressure chamber wall base parts 14-1 (periphery-fixing parts) are formed by dry film resist patterning on the diaphragm 18.

Pressure chamber wall base parts 14-2 are formed by dry film resist patterning on a nozzle substrate (a stainless steel laminated plate of a nozzle plate 10 and a lead-through channel plate 11) which has been produced separately and has nozzles 12 formed therein.

The nozzle substrate and the piezo substrate are aligned, and joining is carried out with heating. The MgO substrate 21 of the piezo substrate is then removed by etching, thus completing the manufacture. By removing the substrate 21, the piezo films 19 bend so as to release the residual stress in the piezo films 19, giving rise to the maximum amount of bend δs during no driving. This amount of bend is related to the rigidity of the diaphragm 18. For example, it is affected by the thickness t of the diaphragm 18.

Next, a description will be given of examples. Firstly, as the basic constitution, the width of the individual electrodes (Pt) 20 was made to be 70 (μm) and the thickness 0.1 (μm), and the piezoelectric constant d31 of the thin-film piezos 19 was made to be (E−12 m/V), the width 70 (μm) and the thickness 3 (μm). The inter-fixing distance of the diaphragm (Cr) 18 was made to be w (μm) and the thickness t (μm). The maximum amount of bend during no driving is represented by δs (μm).

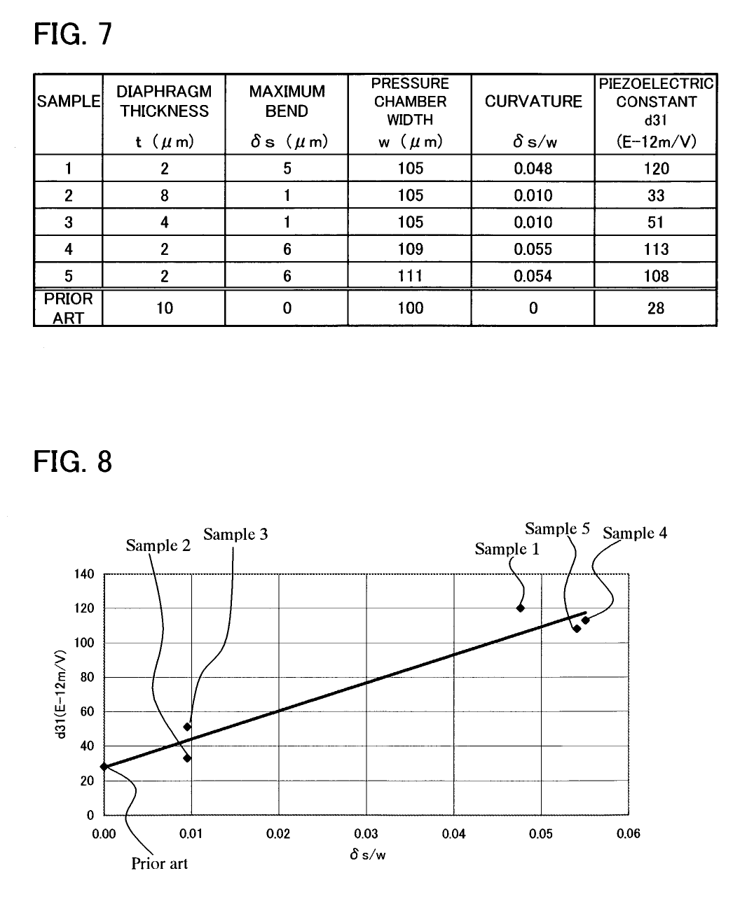

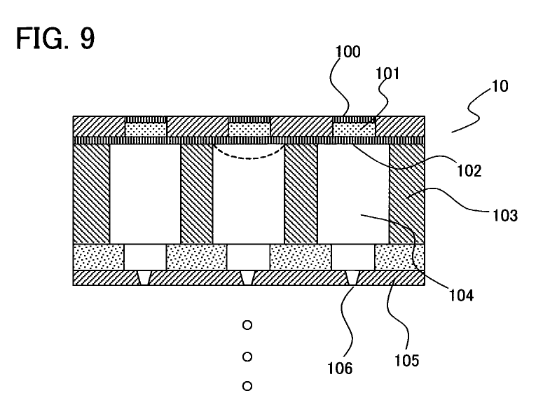

Here, by adjusting the thickness t of the diaphragm 18, a plurality of samples having different maximum amounts of bend δs were produced using the manufacturing method of FIG. 6, and the driving characteristics were evaluated using the static displacement amount (sinusoidal 1 kHz voltage applied). FEM analysis was also carried out on the shape of each of the samples, and by comparing with the evaluation results, the piezoelectric constant d31 was determined. The results are shown in FIGS. 7 and 8. FIG. 7 shows the details of the samples, and FIG. 8 shows the relationship between the curvature δs/w and the piezoelectric constant d31. From the results, it can be seen that, compared with the conventional example, for which the curvature is zero, the piezoelectric constant is higher for the examples (samples 1 to 5) of the present invention, for which the curvature is not zero.

Furthermore, it is clear that the higher the curvature is made, the higher the piezoelectric constant d31 becomes. However, if the curvature is made too high, then this may cause the bimorph parts to break, and hence it is necessary to take care to select the curvature from within a range such that breakage does not occur.

Moreover, regarding the samples for which the piezoelectric constant d31 is large, by making the thickness t of the diaphragm 18 be small, a large amount of bend δs is made to arise, and the structure becomes such that the rigidity of the bimorph parts as a whole is reduced, and hence it becomes easy to carry out displacement driving with a yet lower voltage.

From these results, it can be seen that for a conventional example in which the thickness t of the diaphragm 18 is 10 μm or more, bending does not arise even through the manufacturing process described above. It is thus necessary for the thickness t of the diaphragm 18 to be 8 μm or less; preferably, when the thickness t is 2 μm or less, then the piezoelectric constant can be made large. That is, when the curvature δs/w is 0.04 or more, then the piezoelectric constant d31 can be increased to 3 times or more of the conventional value.

The present invention was described above through an embodiment; however, various modifications are possible within the scope of the purport of the present invention, and these are not excluded from the present invention. For example, the diaphragm 18 was also used as the common electrode, but instead a separate common electrode may be provided on the diaphragm 18. Moreover, a 3-nozzle head was described, but there is no such limitation, with application being possible to a single-nozzle head or to a multi-nozzle head with 2 or more nozzles.

Furthermore, the bend was formed by selecting the thickness of the diaphragm, but can also be realized by selecting the rigidity of the diaphragm, for example by selecting the material of the diaphragm. Moreover, application to an ink jet head was described, but application can also be carried out to a bimorph type actuator having another usage.

### INDUSTRIAL APPLICABILITY

The bimorph part is made to be bent, thus releasing residual stress from when forming the thin-film piezo, and hence the piezoelectric performance of the thin-film piezo can be brought out amply, and desired driving characteristics can be realized with a low voltage. Moreover, because the piezo film can be made thin, it becomes easy to miniaturize the periphery-fixed bimorph type actuator, and to integrate a plurality of elements. Furthermore, through low-voltage driving, the electrical circuitry becomes simpler, which contributes to making the apparatus as a whole smaller and lower in cost. In particular, when the actuator is used as a driving source in an ink jet head, the effects are marked.

1. A bimorph type actuator, comprising:
a diaphragm having a fixed periphery;
a piezo film formed on said diaphragm; and
an electrode film provided on said piezo film;
wherein said piezo film has a shape when not being driven such that the center of said piezo film is bent towards the side of said electrode film.

2. The bimorph type actuator according to claim 1, wherein the relationship between the maximum amount of bend δs of said piezo film and the fixed minor axis width w of said diaphragm is in the following range.
δs/w≧0.04

3. The bimorph type actuator according to claim 1, wherein said piezo film has a perovskite crystal structure grown on a substrate.

4. The bimorph type actuator according to claim 3, wherein said diaphragm is constituted such that said piezo film bends when said substrate is removed.

5. The bimorph type actuator according to claim 4, wherein the thickness of said diaphragm is a thickness such that said piezo film bends when said substrate is removed.

6. An ink jet head, comprising:
a pressure chamber;
a nozzle communicating with said pressure chamber; and
a driving element that applies pressure to said pressure chamber for ejecting ink drops from said nozzle;
wherein said driving element comprises:
a diaphragm having a fixed periphery on a wall member constituting said pressure chamber;
a piezo film formed on said diaphragm; and
an electrode film provided on said piezo film;
and wherein said piezo film has a shape when not being driven such that the center of said piezo film is bent towards the side of said electrode film.

7. The ink jet head according to claim 6, wherein the relationship between the maximum amount of bend δs of said piezo film and the fixed minor axis width w of said diaphragm is in the following range.
δs/w≧0.04

8. The ink jet head according to claim 6, wherein said piezo film has a perovskite crystal structure grown on a substrate.

9. The ink jet head according to claim 8, wherein said diaphragm is constituted such that said piezo film bends when said substrate is removed.

10. The ink jet head according to claim 9, wherein the thickness of said diaphragm is a thickness such that said piezo film bends when said substrate is removed.

11. A multi-nozzle ink jet head, comprising:
a substrate in which are formed a plurality of pressure chambers and a plurality of nozzles communicating with said pressure chambers;
a diaphragm provided on said substrate;
a plurality of piezo films formed on said diaphragm that correspond respectively to said pressure chambers; and
a plurality of electrode films provided respectively on said piezo films;
wherein each of said piezo films has a shape when not being driven such that the center of said piezo film is bent towards the side of said electrode film.

12. A method of manufacturing a bimorph type actuator, comprising the steps of:
forming an electrode film on a substrate;
forming a piezo film on said electrode film;
forming a diaphragm on said piezo film; and
removing said substrate, thus causing the center of said piezo film to bend.

13. A method of manufacturing an ink jet head, comprising the steps of:
forming an electrode film on a substrate;
forming a piezo film on said electrode film;
forming a diaphragm on said piezo film;
forming, on said diaphragm, an ink-ejecting member in which have been formed a pressure chamber and a nozzle; and
removing said substrate, thus causing the center of said piezo film to bend.

14. A method of manufacturing a multi-nozzle ink jet head, comprising the steps of:
forming plurality of electrode films on a substrate;
forming a plurality of piezo films respectively on said electrode films;
forming a common diaphragm on said plurality of piezo films;
forming, on said diaphragm, an ink-ejecting member in which have been formed a plurality of pressure chambers and a plurality of nozzles; and
removing said substrate, thus causing the center of each of said piezo films to bend.
